(19) United States
(12) Patent Application Publication
(10) Pub. No.: US 2010/0004916 A1
(43) Pub. Date: Jan. 7, 2010

(54) Process Analyzer

(75) Inventors: Thomas G Stauder, Belleville, IL (US); Martin C. Haas, Hudson, OH (US); Robert J. Schreiber, St. Louis, MO (US)

Correspondence Address: LEE & HAYES, PLLC, 601 W. RIVERSIDE AVENUE, SUITE 1400, SPOKANE, WA, 99201, US

(73) Assignee: The Boeing Company, Chicago, IL (US)

(21) Appl. No.: 12/167,810

(22) Filed: Jul. 3, 2008

(51) Int. Cl. G06G 7/66; G06G 7/62

(52) U.S. Cl. 703/17

(57) ABSTRACT

Techniques for performing discrete event process simulations are described. A first software module receives production process data and configures the data into a precedence format. The precedence data is then provided to a second software module which modifies the precedence data by introducing variability into the data. A third software module is then selected based on whether processing speed or graphics capability is desired. The selected third software module then performs a discrete event process simulation using the modified data. The results of the discrete event simulation are then provided to the second software module which presents results of the simulation to the user.

### FIELD OF THE DISCLOSURE

The present disclosure relates generally to the field of analyzing production processes, and more particularly to analyzing production processes using discrete event process simulation.

### BACKGROUND

Manufacturing processes are generally dependent upon and constrained by the resources required to perform them. Accordingly, it is advantageous to analyze these dependencies and constraints prior to implementing a process or changing an existing process.

Analyzing process dependencies provides a framework for making informed decisions regarding capital and facility investments. Existing processes also benefit from dependency analysis by determining the effect of new work flows, new resource allocations, and other process changes prior to implementing the changes.

Discrete event process simulations are typically performed to analyze process dependencies and constraints. However, discrete event process simulation modeling generally requires an expert to build the model, create the logic governing the simulation, run the model, and analyze the results. This requisite level of expertise is generally not found in production personnel, who are typically the people with the greatest knowledge of the process and the greatest need to perform this type of analysis.

Accordingly, there is a need for a system and method for enabling non-expert users to perform discrete event process simulation analysis based on existing process data.

Moreover, current discrete event simulation packages lack the ability to tailor the output of the process simulation based on a user's needs. Specifically, a user typically selects the discrete event simulation package based on receiving either a numerical output or a graphical output. Moreover, process simulation packages generally lack standard user interfaces, output their results in various formats, and require specialized training to perform the simulation. Accordingly, there is a need for a discrete event simulation package that outputs simulation data in a variety of different formats.

### SUMMARY

This summary is provided to introduce systems and methods for enabling non-expert users to perform discrete event simulation analysis, which is described below in the Detailed Description. This summary is not intended to identify the essential features of the claimed subject matter, nor is it intended for determining the scope of the claimed subject matter.

In one implementation, a method for analyzing a process may include receiving process and resource data from a first software application. The process and resource data are then transferred to a second software application which provides the capability of editing the data. A discrete event simulation engine is then selected based on whether the user desires processing speed or graphics capability. A simulation model is then created by populating the selected discrete event simulation engine with the edited data from the second software application. The simulation model is then run in accordance with the edited data and the output results are transferred to the second software application for presentation to the user.

In another implementation, a system for analyzing a process may include a first software module to receive production process data and configure the production process data into a precedence format, a second software module to modify the precedence data by introducing variability into the data, and a third software module to receive the modified precedence data and perform a discrete event simulation. The third software module may be selected based on whether processing speed or graphics capability is desired by the user.

The features, functions, and advantages described herein can be achieved independently in various embodiments of the present disclosure, or may be combined in yet other embodiments.

### BRIEF DESCRIPTION OF THE DRAWINGS

The detailed description is set forth with reference to the accompanying figures. In the figures, the left-most reference number digit(s) identifies the figure in which the reference number first appears. The use of the same reference numbers in different figures indicates similar or identical items.

FIG. 1 depicts an illustrative computing environment for performing discrete event process simulation analysis.

FIG. 2 depicts an illustrative Process Analyzer™ architecture.

FIG. 3 depicts an illustrative example of probabilistic routing between various tasks in a process.

FIG. 4 is a block diagram illustrating a method of performing discrete event process simulation using the novel process analyzer.

### DETAILED DESCRIPTION

Systems and methods for enabling non-expert users to perform discrete event simulation analysis are described. Process Analyzer™ is a productivity tool that puts the power of discrete event process simulation in the hands of production support personnel. Process Analyzer™ couples the utility of discrete event simulation software with one of the essential instruments of production support, the precedence diagram.

Process Analyzer™ is a front-end application that provides an environment for importing process definition data from a scheduling application such as, for example, Microsoft Project®, available from Microsoft Corporation of Redmond, Wash. The Process Analyzer™ inputs the precedence diagram data directly to the discrete event simulation engine, thus allowing users with little or no training in discrete event modeling to create and analyze detailed process models.

Through the Process Analyzer™ interface, the user controls the simulation by changing parameters to accommodate specific scenarios, and then analyzes the associated response or output (e.g., cycle times, resource usage, throughput, identify delays and bottlenecks, to name a few).

Moreover, since the Process Analyzer™ interface “front end” is independent or separable from the discrete event simulation engine “backend”, a user may select a discrete event simulation engine based on their needs. For example, a user may select the Delmia Solution's Queuing Event Simulation Tool (Quest®) of Auburn Hills, Mich. discrete event simulation engine which has 3-D graphics capability to create a 3-D image of the process in order to visualize the process, identify errors or omissions in the simulation, etc. Alternatively, a user may select the C++ discrete event simulation (DES) engine which has a greater processing speed for simulations that are unusually complex or when the user has limited time to perform the process simulation.

Although Process Analyzer™ is capable of modeling almost any type of process, it was created to analyze production processes and in particular aircraft assembly processes. As such, it is an ideal tool for forecasting the parameters important to operating an efficient production process such as manpower requirements, cycle span time, rate tooling, shift application, overtime, equipment/ tooling requirements, and work zone capacities.

The Process Analyzer™ is designed to create and run discrete event simulation models. For simplicity, the discrete event modeling entities and constraints may be summarized as “tasks”, “resources”, “schedules”, “process structures”, and “ancillary functions”.

A “task” may be defined as any autonomous operation within a process flow. Tasks generally have distinct start and stop times, defined resource requirements, and may reflect the assignments given shop foreman or leads. An important aspect of a tasks definition is precedence. Process Analyzer™ allows the user to input and edit tasks based on predecessor/successor relationships.

A “resource” is any physical requirement used to complete a task. Process Analyzer™ recognizes three resource categories: manpower (e.g., labor), zones (e.g., work area), and equipment (e.g., jigs and fixtures), and treats each of these resources differently.

Process Analyzer™ can create simulation models based on a variety of different scheduling needs including: release date driven schedules, uniform inter-arrival time schedules, or single release batch operations.

Process Analyzer™ can also network multiple production processes together through the use of work centers and work stations. Work centers serve as a collection point for all the resources used by the connected processes. This allows complex processes, such as the assembly of commercial aircraft, for example, to be modeled and analyzed.

Finally, Process Analyzer™ provides a number of “ancillary features” such as implementing learning curves, model visualization using 3D geometric modeling, multiple simulation runs to conduct statistical analysis, and can be operated so as to support an essentially unlimited number of product types.

### Exemplary Computing Environment

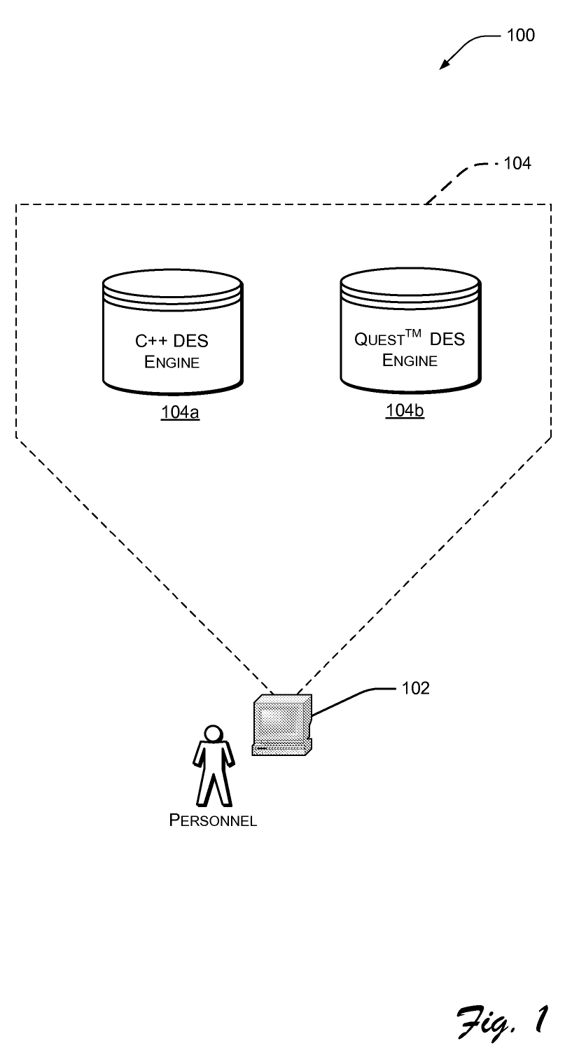

With this in mind, FIG. 1 illustrates an exemplary computing environment 100 for performing discrete event simulation analysis in accordance with an embodiment of the present disclosure. The depicted environment 100 includes a computer 102. The computer 102 includes storage services 104 that may include, for example, a C++ DES engine 104a, a Quest® (g DES engine 104b, or the like. The computer 102 may also include one or more processors capable of executing computer-executable instructions. As depicted, the computer 102 is a personal computer. In another implementation (not shown), a computing environment may includes another personal computer, a work station, a server, a main frame computer, a network of computing devices, or another suitable configuration. In any case, the computing environment 100 includes the discrete event simulation engines 104a and 104b.

Personnel, such as scheduling personnel, production personal, and/or engineering personnel may utilize the Process Analyzer™ to perform discrete event process simulations by way of the computing environment 100. Furthermore, the computer 102 could be a laptop computer, a desktop computer, a notebook computer, a personal digital assistant, or other suitable computing device.

### Exemplary Process Analyzer™ Architecture

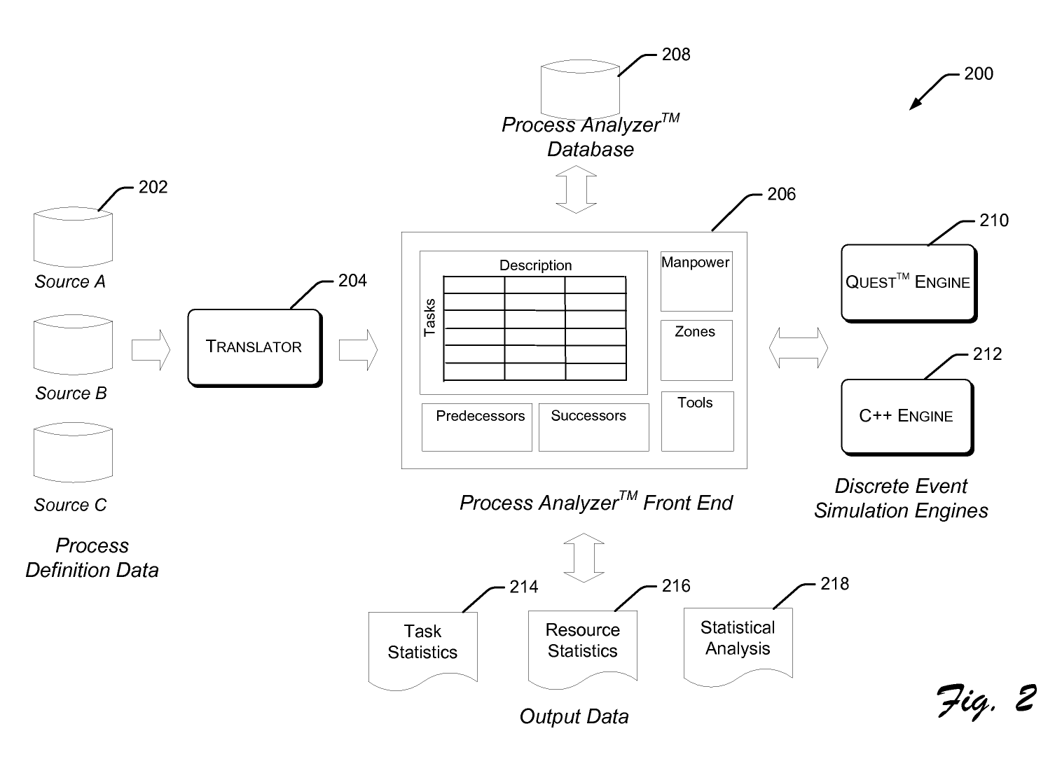

Having described the computing environment 100 for performing discrete event process simulation analysis, the discussion now shifts to the Process Analyzer™ itself. FIG. 2 depicts an illustrative Process Analyzer™ architecture 200, which can be used to perform discrete event process simulations.

First, process definition data may be input via a variety of different sources 202 including: Microsoft Project® available from Microsoft Corporation of Redmond, Wash., or any other suitable means of inputting process definition data.

The process definition data identifies the data source (e.g., Microsoft Project®) and a translator 204 specifies locations at which the data can be found. The process definition data is then transferred to the Process Analyzer™ front end (“PA front end”) 206. The translator 204 may comprise, for example, a subroutine that receives user input identifying a data source is for the process definition data and specifies locations from which the data may be provided.

To simulate different process scenarios, the PA front end 206 allows the user to edit the process definition data. This may include setting the parameters to introduce variability into the process and/or control the behavior of the process simulation. For example, the user may assign specific resources (e.g., manpower, process tools, materials, floor space, to name a few), assign tasks (e.g., based on production shift or production operations), assign cycle times, assign rework percentages, etc.

The process definition data is then passed to a Process Analyzer™ database (PA database) 208 where pre-defined query tables are populated with the process definition data in preparation for creating a discrete event simulation model.

The PA front end processes (i.e., processes performed by the translator and PA front end) are separable from the back end processes (i.e., processes performed by the discrete event simulation engine) and, as such, are capable of interfacing with a variety of discrete event simulation engines. These include the Quest® DES engine 210 and a compiled non-graphic C++ DES engine 212. This flexibility provides the user with the ability to select the Quest® 210 DES engine when 3-D modeling capability is needed or the C++ DES engine 212 when enhanced processing speed is needed (e.g., 50× to 100× greater processing speed than Quest®).

The user then selects the appropriate DES engine based on their need for graphics (e.g., Quest®) or processing speed (e.g., C++). The selected DES engine (210, 212) draws data from the PA database 208 and populates a pre-structured simulation model. The DES simulation engine (210, 212) then runs the simulation according to the parameters selected by the user. Users typically run a number of different process simulations with various input parameters to identify the various process dependencies, process constraints, and to understand the affect of the various input parameters.

When the process simulation is complete, the output data in the form of task statistics 214, resource statistics 216, and statistical analysis 218, for example, is transferred back to the PA front end 206 via the PA database 208.

The purpose of creating and running a simulation model is to create data that illustrates the behavior of a process over time. Once the process data has been created, it must be collected and arranged into a useful format.

Task statistics 214 describe each of the tasks that are performed during the simulation. For example, task statistics 214 may include the time to perform each task including pre-idle time, wait time, cycle time, block time, and post-idle time.

Resource statistics 216 describe the resources used by the various processes and tasks during the simulation. For example, resource statistics may describe which resources are used by each task, how long the resource is used by each task, and the utilization of each resource during the process simulation. The resource statistics may be presented for individual tasks, individual production lines, and/or individual production units.

Statistical analysis 218 presents the overall performance of the process. This may include process throughput, process start and end times, and total process time. This information allows the user to view the performance of the individual processes and is generally the most useful data calculated by the process analyzer. The statistical analysis data 218 may include production rate, completion intervals, cyclical delays, and other important process parameters. This data may then be used to determine the processes limitations as well as conflicts between the various stations and tasks.

In addition, the output data (i.e., task statistics 214, resource statistics 216, and statistical analysis 218) may be exported from the Process Analyzer™ to one or more software applications, such as Microsoft Project®, for example. These software application may then be used to determine the process bottle necks, determine the impact of shift applications, etc.

### Probabilistic Routing

Traditional scheduling software packages generally create discrete and constant relationships between associated tasks (e.g., tasks are generally performed consecutively in a fixed or constant order). However, there are many situations where it is desirable to select one of several tasks that may be performed (e.g., multiple processes perform the same function or achieve the same or similar results). This situation can also arise when one article in a series of articles requires testing, when an article must be reworked, or when an articles configuration is changed. In each of these situations, the next task may be defined in terms of the probability of that task being performed (e.g., 50% chance).

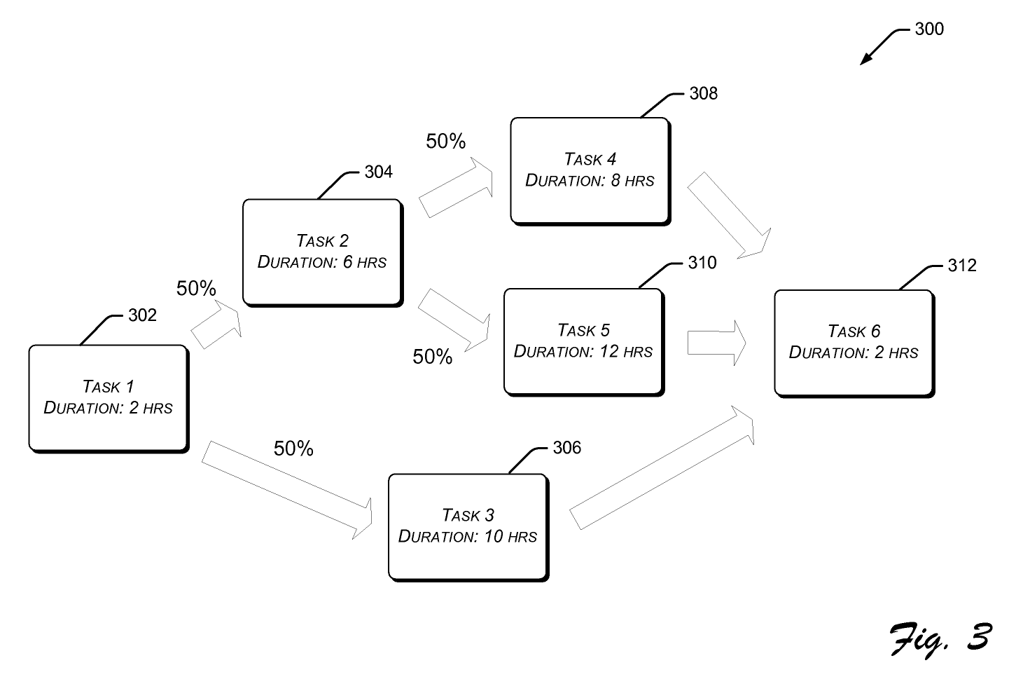

FIG. 3 illustrates 5 tasks that may be performed as part of a single process 300. In this example, there is an equal probability (50%/50%) between Task 1 and Task 2 being performed, and a 50% probability between Task 1 and Task 3 being performed. Moreover, there is 50% probability that Task 4 or Task 5 will be selected if Task 2 is selected.

It should be appreciated that the probability split between the various tasks (e.g., Task 1 and Task 2, Task 1 and Task 3, Task 4 and Task 5) does not have to be 50/50 and could have easily been 60/40, 75/25, 90/10, etc. Likewise, there may be situations where multiple process routes or branches occur (e.g., Task 4, Task 5, Task X, Task X+1, etc). In either event, the probability splits must total 100% (e.g., 50%+50%, 75%+25%, 50%+30%+20%, etc.).

Note that in each of the examples, at least one task is left out or excluded during each pass through the process. For example, if Task 3 is selected, then Task 2, Task 4, and Task 5 are excluded. In contrast, if Task 2 and Task 4 are selected, then Task 3 and Task 5 are excluded. When a task is excluded, the time required to perform that task (i.e., process time) is not incurred by the process and drops out. Accordingly, the tasks that are selected and performed can have a significant effect on the overall time required to perform the process.

For example, if Task 3 is selected the total process time is 14 hours (i.e., 2 hrs+10 hrs+2 hrs). Alternatively, if Task 2 and Task 4 are selected, the total duration is 18 hours (i.e., 2 hrs+6 hrs+8 hrs+2 hrs). The following table summarizes the probability that the specific process path is performed and the time needed to perform the tasks associated with that process path.

| Process Path | Probability | Process Time |
|---|---|---|
| T1, T2, T4, and T6 | 25% | 18 hrs |
| T1, T2, T5, and T6 | 25% | 22 hrs |
| T1, T3, and T6 | 50% | 14 hrs |

From the table one sees that there is a 25% probability that either Task 4 or Task 5 will be performed and that there is a 4 hour time difference between the two process paths. In contrast, there is a 50% probability that Task 3 will be performed and that the process path associated with Task 3 takes significantly less time to perform then the alternative paths (i.e., Task 4 and Task 5). Accordingly, when there are multiple probabilistic routes and/or appreciable time differences between process routes, there can be a significant affect to the overall process.

### Exemplary Discrete Event Simulation Methods

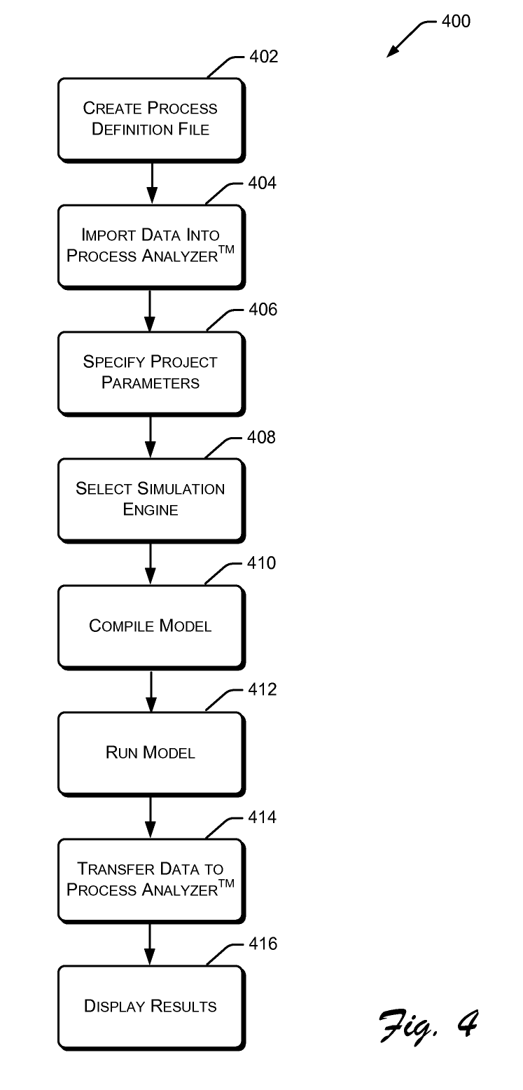

FIG. 4 depicts an illustrative method for performing discrete event process simulations 400 in accordance with an embodiment. Method 400 is illustrated as a collection of blocks representing a sequence of operations that can be implemented in hardware, software, or a combination of both. In the context of software, the blocks represent computer instructions that, when executed by one or more processors, perform the recited operations.

The method 400 may begin with the user creating a process definition file from process data that may be related to an aircraft assembly process, at block 402. The process definition file may be in the form of a precedence diagram, such as a Microsoft Project® diagram, Gantt chart, or flowchart, etc. The process definition file generally includes resources (e.g., manpower, tooling, floor space, etc.), the tasks being performed, and time needed to perform those tasks. Accordingly, the process definition file may specify overall start and end events for the various processes, as well as the predecessor and successor tasks that comprise that process.

The process definition file may then be inputted into the PA front end where it may be stored for subsequent analysis, at block 404. Alternatively, the process definition file may be reconfigured into a flat file format for use by the DES engine.

At block 406, the process definition data is edited and parameters are set to introduce variability and/or control the process simulation's behavior. Process variability may be introduced in the form of cycle times, machine reliability, scrap rate variability, labor variability, as well as other known variations associated with performing tasks in a process. The process variability may also be introduced in the form of a statistical distribution (e.g., Gaussian distribution for a normal distribution).

Since variations typically exist between successive executions of the model, it may be advantageous to execute the process simulation model a number of different times. Accordingly, the user may specify the number of times the model is to be executed.

The process data may then pass to the PA database where predefined query tables are populated with the appropriate data elements to create the DES model.

The user then selects an appropriate DES engine based on their specific needs. If the user desires a graphical representation of the process to trouble shoot or visualize the production process, they could select a DES engine with graphics capability (e.g., Quest® engine). Alternatively, if the user was performing a complicated or time consuming process simulation they could select a high speed DES engine with quicker processing speed (e.g., C++ engine), at block 408.

Once the user has selected a DES engine, the simulation engine draws process data from the database query tables to populate the model created by the selected discrete event simulation engine, at block 410.

The discrete event simulation model is then run according to the parameters set by the user, at block 412.

Upon completion of the simulation(s), the output data is transferred from the DES engine back to the PA front end via the PA data base, at block 414. The PA front end then assembles the output data into reports, graphs, charts, or other forms of output which detail the behavior of the tasks and resources during the simulation, at block 416. For example, task statistics may be formatted to present the time required to perform each task in the process, idle time associated with the task, cycle time associated with the task, or other process data and statistics of interest.

The output data may be further organized to report the utilization of the resources needed to perform the process (e.g., time that a resource is used). In addition, the task statistics and resource utilization may be processed and presented in various graphical representations of the output data.

Alternatively, the output data may be exported from the PA front end to other software applications (e.g., Microsoft Project®) so that additional analysis can be performed and/or the process data presented in other formats.

Finally, if the user wishes to make changes to the model, or rerun the model, they may change selected portions of the model at block 406, create a revised simulation model at block 410, and run the revised model at block 412.

### CONCLUSION

While several exemplary implementations have been illustrated and described, it will be appreciated that the various changes can be made without departing from the spirit and scope of the disclosure. The scope of the disclosure, therefore, should be determined form the following claims and equivalents thereof.

What is claimed is:

1. A method of analyzing a production process comprising:
receiving process data and resource data from a first software application;
importing the process data and resource data into a second software application, the second software application configured to edit the process data and resource data;
selecting a discrete event simulation engine based on processing speed or graphics capability;
creating a simulation model by populating the selected discrete event simulation engine with the edited process data and resource data from the second software application;
running the simulation model in accordance with the edited process data and resource data to create output data; and
transferring the output data to the second software application for presentation to a user.

2. A method as recited in claim 1, wherein the process data and resource data are received in a precedence format.

3. A method as recited in claim 1, wherein the process data comprises a plurality of tasks, each task having an associated probability that the task will be perform as part of a process flow and a time associated with performing the task.

4. A method as recited in claim 1, wherein the discrete event simulation engine comprises a high speed discrete event simulation engine or a discrete event simulation with graphics capability.

5. A method as recited in claim 1, wherein the process data and resource data are edited by introducing variability into the data.

6. A method as recited in claim 5, wherein variability is introduced into the data by varying one or more of a task relationship, a cycle time, and a resource.

7. A method as recited in claim 1, wherein the simulation model is run based on a release driven schedule, a uniform inter-arrival schedule, or a single release batch operation.

8. A method as recited in claim 1, further comprising processing the process data and resource data with a third software application to create a flat data file and transferring the flat data file to the selected discrete event simulation engine.

9. A method as recited in claim 1, further comprising transferring the output data from the second software application to a third software application to analyze and/or present the output data.

10. A method as recited in claim 1, further comprising transferring the process data to a database where query tables are populated to create the discrete event simulation model.

11. A method as recited in claim 10, further comprising drawing data from the query tables to populate the discrete event simulation model.

12. A computer-readable storage medium, comprising computer-executable instructions that when executed by a computer processor performs a method comprising:
receiving process data for a production process from a first software application;
editing the process data by introducing variability into the process data with a second software application;
selecting a discrete event simulation engine based on processing speed or graphics capability;
creating a simulation model by populating the selected discrete event simulation engine with the edited process data;
running the simulation model to simulate the production process; and
transferring at least one output file to the second software application for presentation to a user.

13. A computer readable storage medium as recited in claim 12, wherein the process data is received as a precedence diagram.

14. A computer readable storage medium as recited in claim 12, wherein the process data comprises a plurality of tasks, each task having an associated probability that the task will be performed as part of a process flow and a time associated with performing the task.

15. A computer readable storage medium as recited in claim 12, wherein the discrete event simulation engine comprises a high speed discrete event simulation engine or a discrete event simulation with graphics capability.

16. A computer readable storage medium as recited in claim 12, wherein variability is introduced into the process data by varying a task relationship, a cycle time, or a resource.

17. A system for analyzing a production process, comprising:
a first software module configured to receive production process data and format the production process data into a precedence format;
a second software module configured to receive the precedence data and modify it by introducing variability into the precedence data; and
a third software module configured to receive the modified precedence data and perform a discrete event simulation, wherein the third software module is selected based on the software module's processing speed or graphics capability.

18. A system as recited in claim 17, wherein the production process data is received as a precedence diagram.

19. A system as recited in claim 17, wherein the production process data comprises a plurality of tasks, each task having an associated probability that the task will be perform as part of a process flow and a time associated with performing the task.

20. A system as recited in claim 17, further comprising a forth software module to present at least one result from the discrete event simulation to a user.
